(19) United States
(12) Patent Application Publication
(10) Pub. No.: US 2014/0180949 A1
(43) Pub. Date: Jun. 26, 2014

(54) SYSTEM AND METHOD FOR AUTOMATED CODING AND TESTING OF BENEFITS

(71) Applicant: COGNIZANT TECHNOLOGY SOLUTIONS INDIA PVT. LTD., Chennai (IN)

(72) Inventors: Paramesh Ramasamy, Chennai (IN); Janakiraman Radhakrishnan, Chennai (IN); Balamurugan Subramanian, Chennai (IN); Gunasekaran Ramasamy, Chennai (IN); Sankar Kasilingam, Chennai (IN); Gurumurthy Harikrishnan, Chennai (IN); Gopi Krishnappa, Chennai (IN)

(73) Assignee: COGNIZANT TECHNOLOGY SOLUTIONS INDIA PVT. LTD., Chennai (IN)

(21) Appl. No.: 13/796,151

(22) Filed: Mar. 12, 2013

(30) Foreign Application Priority Data
Dec. 24, 2012 (IN) 5391/CHE/2012

(51) Int. Cl. G06Q 10/10

(52) U.S. Cl. CPC G06Q 10/1057
USPC 705/322

(57) ABSTRACT

A system and method for automated coding and testing of insurance benefits is provided. The system comprises a user interface to receive data pertaining to benefits based on insurance benefits contracts and to create Benefit Plan Designs (BPDs) using the received data. The system further comprises a benefits mapping module to map the benefits from the BPDs with pre-stored benefits in a repository. Further, the system comprises a benefit code translator to translate the mapped benefits into codes or mnemonics and a benefit code updating engine to update the codes or mnemonics into one or more claims platforms. In addition, the system comprises a test scenario mapping module to generate test claims and expected results and to execute the generated test claims on the one or more claims platforms to generate actual test results. The system also comprises a validation engine to validate the codes or mnemonics.

### FIELD OF THE INVENTION

The present invention relates generally to insurance benefits management. More particularly, the present invention provides a system and method for capturing the insurance benefits in a web form and automatically coding and testing the insurance benefits in a claims platform.

### BACKGROUND OF THE INVENTION

Benefits coding and testing is a process in insurance industry whereby various insurance benefits stated in the benefits contract (also known as benefits plan) such as health insurance benefits contract with subscribers are coded and tested at payer organization. Usually, an individual or a corporate on behalf of their employees opts for an insurance benefits contract with a payer organization such as a medical insurance provider. The insurance benefits contract contains details such as insurance coverage and the benefits provided by the payer organization to one or more subscribers. Based on the insurance benefits contract, one or more benefits analysts in the payer organization prepare a Benefit Plan Design (BPD). The BPD is a document comprising the benefits provided by the payer organization to the one or more subscribers, the coverage details and other technical details necessary for configuring the insurance benefits contract into a claims platform. Typically, the insurance benefits contract is coded into the claims platform to facilitate faster processing of claims. Once the coding of the insurance benefits contract into the claims platform is done, testing is performed by the payer organization to ensure that the claims platform processes the claims in an appropriate and expected manner.

Conventionally, various methods and systems exist for coding and testing of the benefits at payer organizations. For example, the benefits are coded and tested manually by the payer organizations. The payer organizations employ skilled benefits coders to manually code and test the benefits. However, the coded and tested benefits are generally not error free and often lead to incorrect payment for claims. Moreover, the payer organizations take more time to complete the coding and testing of the benefits. This affects both the subscribers and the payer organizations. In addition, shortage of skilled benefit coders for coding and testing of the benefits during high enrolment period leads to delays. Quality of coding and testing also suffers due to work pressure and stringent deadlines. Also, the existing methods and systems for testing and coding of the benefits at the payer organizations are discrete and handled as separate processes by different teams at different time frames having non-standard documentation techniques/formats which lead to inconsistency in the information. Further, changes in one document are not reflected in the other documents due to lack of traceability and inconsistent formats. Therefore, an integrated, automated and scalable system and method for coding and testing of benefits does not exist that would facilitate error free coding and testing of the benefits.

In light of the above, there is a need for an automated system and method for capturing the benefits details in a web form which can be subsequently used for coding and testing of the benefits. Further, there is a need for an integrated system and method that would facilitate error free coding and testing of the benefits thereby facilitating accurate processing of the claims and avoiding incorrect payments. In addition, there is a need for a system and method which is efficient and easily scalable to meet increased demand during high enrolment periods and reduce dependency on the benefits coders.

### SUMMARY OF THE INVENTION

A system, a computer-implemented method and a computer program product for automated coding and testing of insurance benefits is provided. The system comprises a user interface configured to receive data pertaining to one or more benefits based on one or more insurance benefits contracts and further configured to create one or more Benefit Plan Designs (BPDs) using the received data. The system further comprises a benefits mapping module configured to map the one or more benefits from the created one or more BPDs with one or more pre-stored benefits in a repository. Further, the system comprises a benefit code translator configured to translate the one or more mapped benefits into codes or mnemonics. Furthermore, the system comprises a benefit code updating engine configured to update the translated codes or mnemonics into one or more claims platforms. In addition, the system comprises a test scenario mapping module configured to generate one or more test claims and one or more expected results based on the one or more mapped benefits and further configured to execute the generated one or more test claims on the one or more claims platforms having the updated codes or mnemonics to generate one or more actual test results. The system also comprises a validation engine configured to validate the updated codes or mnemonics by matching the generated one or more actual test results with the one or more expected results.

In an embodiment of the present invention, the user interface provides at least one of: web forms and templates to receive the data pertaining to the one or more benefits. In an embodiment of the present invention the received data related to the benefits includes at least one of: benefit details, coverage details, copayment, coinsurance and deductible values. In an embodiment of the present invention, the one or more insurance benefits contracts contain information related to at least one or more insurance benefits provided by a payer organization to one or more subscribers. In an embodiment of the present invention, the received data is arranged in a predetermined order to create the one or more BPDs. In an embodiment of the present invention, the repository stores at least one of: the one or more pre-stored benefits, the received data, the created one or more BPDs, web forms and templates. In an embodiment of the present invention, the one or more pre-stored benefits include at least one of: services covered, sub-services covered, coverage details, coinsurance, deductible and copayment values. In an embodiment of the present invention, the benefit code translator is configured to translate the one or more mapped benefits into the codes or mnemonics by matching the one or mapped benefits with data in one or more lookup tables and fetching the codes or mnemonics corresponding to the matched data. In an embodiment of the present invention, the generated one or more test claims correspond to one or more test scenarios. In an embodiment of the present invention, values related to at least one of: deductible, coinsurance, copayment and coverage from the one or more mapped benefits are associated with the generated one or more test claims to generate the one or more expected results. In an embodiment of the present invention, the system further comprising a configurable test scenario repository for storing at least one of: one or more pre-stored test scenarios, the one or more test scenarios, the one or more expected results, the one or more test claims and the one or more actual test results. In an embodiment of the present invention, if the one or more actual test results do not match the one or more expected test results then one or more errors in the updated codes or mnemonics are detected and reported. In an embodiment of the present invention, output from the validation engine is reported via the user interface in various forms including at least one of: a Portable Document Format (PDF), a spreadsheet, a word processor document, an HTML document and a web page. In an embodiment of the present invention, the translated codes or mnemonics are updated into the one or more claims platforms using a multi-process architecture. Further, the generated one or more test claims are executed on the one or more claims platforms having the updated codes or mnemonics using the multi-process architecture. In an embodiment of the present invention, the system further comprising a database format translator configured to present the one or more mapped benefits into one or more pre-determined formats and a database update engine configured to update the presented one or more benefits on one or more external systems. In an embodiment of the present invention, the one or more external systems include at least one of: a helpdesk system, a call centre system, an Enterprise Information Portal (EIP), a corporate portal, a Customer Relationship Management (CRM) system and their associated repositories.

The computer-implemented method for automated coding and testing of benefits, via program instructions stored in a memory and executed by a processor, comprises receiving data pertaining to one or more benefits based on one or more insurance benefits contracts. The computer-implemented method further comprises creating one or more Benefit Plan Designs (BPDs) using the received data pertaining to the one or more benefits. Further, the computer-implemented method comprises mapping the one or more benefits from the created one or more BPDs with one or more pre-stored benefits. Furthermore, the computer-implemented method comprises translating the one or more mapped benefits into codes or mnemonics. In addition, the computer-implemented method comprises updating the translated codes or mnemonics into one or more claims platforms. Also, the computer-implemented method comprises generating one or more test claims and one or more expected results based on the one or more mapped benefits. The computer-implemented method further comprises executing the generated one or more test claims on the one or more claims platforms having the updated codes or mnemonics to generate one or more actual test results. The computer-implemented method also comprises validating the updated codes or mnemonics by matching the generated actual test results with the expected results.

In an embodiment of the present invention, the step of translating comprises matching the one or mapped benefits with data in one or more lookup tables and fetching the codes or mnemonics corresponding to the matched data. In an embodiment of the present invention, the computer implemented method further comprising presenting the one or more mapped benefits into one or more pre-determined formats and updating the presented one or more benefits on one or more external systems.

The computer program product for automated coding and testing of benefits comprising: a non-transitory computer-readable medium having computer-readable program code stored thereon, the computer-readable program code comprising instructions that when executed by a processor, cause the processor to receive data pertaining to one or more benefits based on one or more insurance benefits contracts. The processor further creates one or more Benefit Plan Designs (BPDs) using the received data pertaining to the one or more benefits. Further, the processor maps the one or more benefits from the created one or more BPDs with one or more pre-stored benefits. Furthermore, the processor translates the one or more mapped benefits into codes or mnemonics. Also, the processor updates the translated codes or mnemonics into one or more claims platforms. In addition, the processor generates one or more test claims and one or more expected results based on the one or more mapped benefits. The processor further executes the generated one or more test claims on the one or more claims platforms having the updated codes or mnemonics to generate one or more actual test results. The processor then validates the updated codes or mnemonics by matching the generated actual test results with the expected results.

In an embodiment of the present invention, translating the one or more mapped benefits into codes or mnemonics comprises matching the one or mapped benefits with data in one or more lookup tables and fetching the codes or mnemonics corresponding to the matched data. In an embodiment of the present invention, the computer program product further comprises presenting the one or more mapped benefits into one or more pre-determined formats and updating the presented one or more benefits on one or more external systems.

### BRIEF DESCRIPTION OF THE ACCOMPANYING DRAWINGS

The present invention is described by way of embodiments illustrated in the accompanying drawings wherein:

FIG. 1 is a block diagram illustrating a system for automated coding and testing of insurance benefits in accordance with an embodiment of the present invention;

FIG. 2 is a detailed block diagram of a testing and validation engine in accordance with an embodiment of the present invention;

FIGS. 3A and 3B represent a flowchart illustrating a method for automated coding and testing of insurance benefits in accordance with an embodiment of the present invention;

FIG. 4 illustrates a multi-process architecture for automated coding and testing of insurance benefits in accordance with an exemplary embodiment of the present invention; and

FIG. 5 illustrates an exemplary computer system for automated coding and testing of insurance benefits in accordance with an embodiment of the present invention.

### DETAILED DESCRIPTION OF THE INVENTION

A system and method for capturing insurance benefits in a web form and coding and testing of the insurance benefits is described herein. The invention provides for an integrated automated system and method that would facilitate error free coding and testing of benefits thereby facilitating accurate processing of claims and avoiding incorrect payments. The invention further provides a system and method which is efficient and scalable to meet increased demand during high enrolment periods and reduce dependency on benefits coders.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

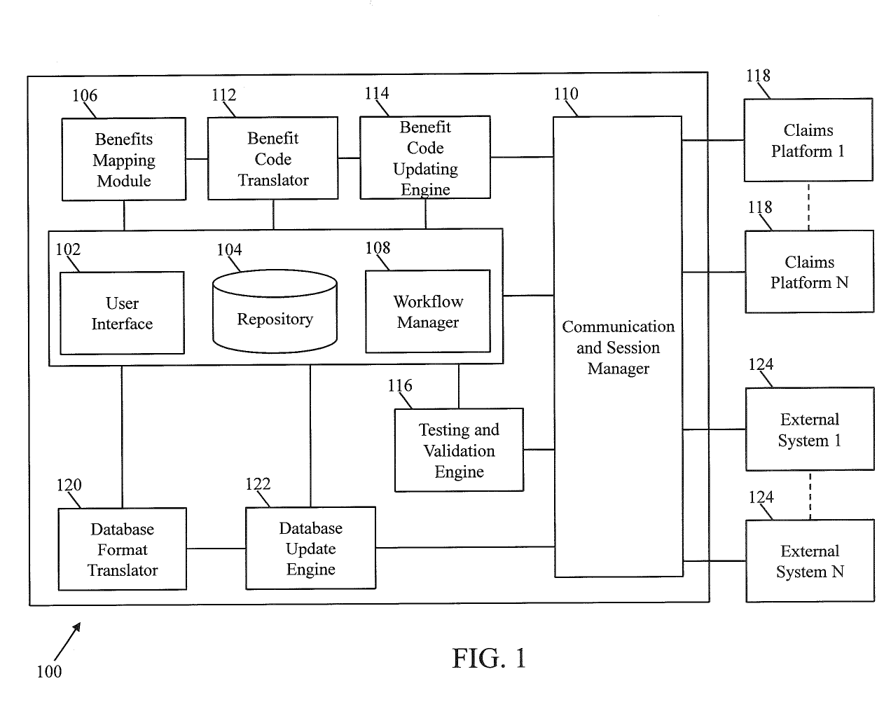

FIG. 1 is a block diagram illustrating a system for automated coding and testing of the insurance benefits in accordance with an embodiment of the present invention. The system 100 comprises a user interface 102, a repository 104, a benefits mapping module 106, a workflow manager 108, a communication and session manager 110, a benefit code translator 112, a benefit code updating engine 114, a testing and validation engine 116, a database format translator 120 and a database update engine 122. The system 100 is connected to one or more claims platforms 118 and one or more external systems 124. In an exemplary embodiment of the present invention, the system 100 is designed on a platform based on .NET technology.

The user interface 102 is a front end interface configured to receive, from one or more users, data pertaining to one or more benefits based on insurance benefits contract between payer organization and one or more subscribers.

In various embodiments of the present invention, the user interface 102 is an interactive interface such as, but not limited to, a Graphical User Interface (GUI), a character user interface and a touch screen interface. In an embodiment of the present invention, the user interface 102 receives data from the one or more users via an electronic communication device including, but not limited to, a desktop, a notebook, a laptop, a mobile phone, a smart phone and a Personal Digital Assistant (PDA). The received data pertaining to the one or more benefits includes, but not limited to, coverage details, benefits details, copayment, co-insurance, employer data, eligibility details, deductibles etc. In various embodiments of the present invention, the one or more users include, but not limited to, benefits analysts, employees and sales executives of the payer organizations. In an embodiment of the present invention, the payer organization includes, but not limited to, an insurance provider and typically a health insurance provider.

In an embodiment of the present invention, the user interface 102 is configured to create one or more Benefit Plan Designs (BPDs) using the received data pertaining to the one or more benefits. A BPD is a document comprising the benefits provided by the payer organization to the one or more subscribers, coverage details, benefits details, copayment, co-insurance, deductibles, employer data, eligibility details and additional technical details for configuring the insurance benefits contract and coding the benefits in the one or more claims platforms 118. Further, the BPD is based on the insurance benefits contract/plan opted by an individual or a corporate on behalf of their employees with the payer organization. In an embodiment of the present invention, the data pertaining to the one or more benefits received from the one or more users via various interfaces such as, web forms, templates etc. is arranged in a predetermined order to create the BPD. The one or more created BPDs are stored in the repository 104.

The repository 104 also stores data related to, but not limited to, the web forms and templates, one or more pre-stored benefits, the received data pertaining to the one or more benefits, insurance benefits contracts, benefits details, and one or more history and audit details of previous insurance benefits contracts. The repository 104 may include any relational database management system such as, but not limited to, Oracle, DB2, SQL server, MS Access, MySQL and SQLite.

In an embodiment of the present invention, the one or more BPDs prepared by the one or more users are accessed and approved by one or more support users such as, but not limited to, the benefits coder, benefits tester and external DataBase (DB) operators by logging on to the system 100. If the one or more support users do not approve of the one or more BPDs, the one or more users preparing the BPDs are communicated via the user interface 102 to provide clarifications and modify the one or more BPDs suitably.

The benefits mapping module 106 is configured to map the one or more benefits from the one or more BPDs with the one or more pre-stored benefits. At the time of configuring the system 100 for the payer organization, an administrator creates a master list of pre-stored benefits containing all the benefits provided by the payer organization to its subscribers. Further, the administrator can also configure new benefits in the master list of the pre-stored benefits as and when required by the payer organization. The administrator also creates various lookup tables for the purpose of coding and testing. The lookup tables contain codes or mnemonics and additional data that represent the pre-stored benefits.

In an embodiment of the present invention, the user interface 102 retrieves a list of the one or more pre-stored benefits from the repository 104 and renders it on the user interface 102. The one or more users then select the one or more benefits from the rendered list of the one or more pre-stored benefits based on the insurance benefits contract to create the one or more BPDs. Based on the user selection, the benefits mapping module 106 maps the selected one or more benefits with the one or more pre-stored benefits in the repository 104 to retrieve additional data related to the mapped one or more benefits including, but not limited to, copayment, coinsurance, deductibles, limits, etc. In an embodiment of the present invention, the mapped one or more benefits and the additional data is used for coding and testing. In various embodiments of the present invention, the one or more pre-stored benefits of the one or more BPDs include at least one of: services covered, sub-services covered, coverage details, coinsurance, deductibles and copayment values. In an embodiment of the present invention, the one or more benefits are provided by the payer organization for various services such as, but not limited to, acupuncture, allergy, maternity, radiation therapy, anesthesia, ambulance, etc. In an embodiment of the present invention, the payer organization may provide the one or more benefits in the form of service level benefits or group level benefits based on the insurance benefits contract. The service level benefits include the benefits for various services desired by the subscribers of the insurance benefits contract. The group level benefits include benefits that are often provided by the payer organization to members of a particular group, for example, employees of a particular employer.

The workflow manager 108 facilitates controlling and tracking the progress of workflow between various components of the system 100. The workflow manager 108 facilitates controlling various tasks such as, but not limited to, receiving data from the one or more users via the user interface 102, creating the one or more BPDs, coding the benefits via the benefit code translator 112, updating the coded benefits via the benefit code updating engine 114, testing the benefits via the testing and validation engine 116 and updating the one or more external systems 124. The workflow manager 108 also tracks the number of transactions performed by the system 100. In addition, the workflow manager 108 facilitates communication between the one or more users regarding the one or more BPDs.

The communication and session manager 110 facilitates information exchange between various modules of the system 100. Also, the communication and session manager 110 remembers data exchanged between various modules for efficient processing. The communication and session manager contains configuration information for identifying and authenticating the one or more users and enable them to use the system 100 and its various modules. The communication and session manager 110 communicates with the user interface 102 to create sessions for the one or more users logging into the system 100. The communication and session manager 110 also maintains multiple sessions in order to facilitate multiple users to access the system 100. The communication and session manager 110 facilitates communication between the user interface 102, the repository 104, the benefit code translator 112, the benefit code updating engine 114, the testing and validation engine 116, the one or more claims platforms 118, the DB format translator 120, the DB update engine 122 and the one or more external systems 124.

The benefit code translator 112 is configured to translate the one or more mapped benefits from the one or more BPDs stored in the repository 104 into the codes or mnemonics. The translated codes or mnemonics help in configuring the one or more claims platforms 118 with respect to insurance benefits contracts to facilitate quick processing of claims made by the one or more subscribers and further facilitate early and correct payments. In an embodiment of the present invention, the codes or mnemonics are instructions specific to a claims platform 118 provided by a vendor of the claims platform 118.

In an embodiment of the present invention, the benefit code translator 112 comprises translation logic to automatically translate the one or more mapped benefits into corresponding codes or mnemonics for each of the one or more claims platforms 118. In an embodiment of the present invention, the translation logic is in the form of program instructions having intelligence to map the one or more mapped benefits with data in one or more lookup tables. The data in the one or more lookup tables comprises of: the mapped one or more benefits and corresponding codes or mnemonics which are provided by the vendor of the claims platform 118. In an embodiment of the present invention, during translation, content of the one or more mapped benefits is matched with the one or more benefits in the one or more lookup tables and corresponding pre-stored codes and mnemonics are retrieved. In an embodiment of the present invention, some lookup tables are used for the purpose of coding of the one or more mapped benefits and some lookup tables are used only for the purpose of testing of the one or more mapped benefits.

In an exemplary embodiment of the present invention, the one or more lookup tables for the purpose of coding include, but not limited to, services tables, conditions tables, parameter classification tables etc. The services tables comprise the codes or mnemonics to represent the various services covered by the payer organization such as, but not limited to, allergy, acupuncture, surgery, maternity, anesthesia, pathology and laboratory etc. The conditions tables comprise the codes or mnemonics to represent various conditions such as, but not limited to, copayment for in-network, copayment for out-of-network, individual deductible for in-network, individual deductible for out-of-network etc. The parameter classification tables comprise the codes or mnemonics to represent various parameters such as, but not limited to, co-payment, family deductible, individual deductible, calendar year etc.

In an exemplary embodiment of the present invention, the benefit code translator 112 matches a service such as allergy from a mapped benefit to its corresponding code or mnemonic listed in a lookup table such as services table and fetches the corresponding code or mnemonic. The benefit code translator 112 then checks coverage and conditions associated with allergy such as, but not limited to, deductible for allergy for in-network healthcare provider, copayment for allergy for out-of-network healthcare provider, etc. The benefit code translator 112 then fetches codes or mnemonics for the coverage and the conditions associated with allergy from the conditions tables and other lookup tables. The values associated with the coverage, deductibles, coinsurance, copayment etc. for allergy are obtained from the mapped benefit based on the fetched codes or mnemonics. All the fetched codes or mnemonics and the obtained values are then stored in a grid or a table which is suitably updated on the claims platform 118.

Once the one or more mapped benefits are translated into codes or mnemonics, the communication and session manager 110 establishes a connection between the benefit code updating engine 114 and the appropriate claims platform 118.

The benefit code updating engine 114 then updates the translated codes or mnemonics representing the one or more mapped benefits on the one or more claims platforms 118 via various scripts or programming logic. In an embodiment of the present invention, the vendor of the one or more claims platforms 118 provides information which facilitates the benefit code updating engine 114 to update the translated codes or mnemonics into various screens and fields of the claims platform 118. In various embodiments of the present invention, once the one or more benefits are coded into the one or more claims platforms 118, the control is transferred to the testing and validation engine 116 via workflow manager 108 for testing.

The testing and validation engine 116 facilitates testing and validation of the translated codes or mnemonics representing the one or more benefits (coded benefits) updated in the one or more claims platforms 118. In order to test and validate the updated codes or mnemonics, the testing and validation engine 116 generates one or more test scenarios, one or more expected results and one or more test claims. Once the one or more test scenarios, the one or more expected results and the one or more test claims are generated, the testing and validation engine 116 checks if the updated codes or mnemonics perform processing of the claims and calculation of the benefits as per the one or more BPDs by executing the test claims on the claims platform 118.

In an embodiment of the present invention, the testing of the codes or mnemonics representing the one or more benefits (the coded benefits) updated in the one or more claims platforms 118 is performed using the one or more test claims that are executed automatically by the testing and validation engine 116. The results generated by execution of the one or more test claims on the one or more claims platforms 118 are one or more actual test results. The testing and validation engine 116 then compares the one or more actual test results with the one or more expected results to validate that the one or more benefits are accurately coded/translated into the codes or mnemonics. The testing and validation engine 116 also detects one or more errors pertaining to the codes or mnemonics representing the one or more benefits if the one or more actual test results do not match the one or more expected results.

Further, the testing and validation engine 116 communicates with the benefit code translator 112 via workflow manager 108 to facilitate correcting the one or more detected errors in the updated codes or mnemonics. The benefit code translator 112 is configured to re-translate the one or more benefits from the one or more BPDs into specific codes or mnemonics to correct the one or more detected errors. The benefit code updating engine 114 then updates the re-translated codes or mnemonics into the one or more claims platforms 118.

The one or more claims platforms 118 are existing systems that facilitate processing of the claims. The one or more claims platforms 118 are connected with the system 100. The system 100 acts as a wrapper to the one or more claims platforms 118 and facilitates operating the one or more claims platforms 118 in an efficient manner. The one or more claims platforms 118 are configured to execute the one or more test claims to generate the one or more actual test results. The one or more claims platforms 118 comprise information related to the one or more benefits updated by the benefit code updating engine 114 in the form of the codes or mnemonics (the coded benefits). In an embodiment of the present invention, the one or more claims platforms 118 are mainframe based systems. In another embodiment of the present invention, the one or more claims platforms 118 are web-based system. In various embodiments of the present invention, the one or more claims platforms 118 include, but not limited to, a web portal, a corporate portal, an extranet and a client portal.

The DB format translator 120 is configured to present information related to the one or more mapped benefits from the one or more BPDs stored in the repository 104 into one or more predetermined formats that can be rendered on the one or more external systems 124. In various embodiments of the present invention, the DB format translator 120 filters and presents selective information related to the one or more benefits into useful and meaningful information that can be comprehended by the one or more support users using the one or more external systems 124. In an embodiment of the present invention, the DB format translator 120 facilitates presenting benefits from the one or more BPDs into a suitable format by referencing various lookup tables. In an embodiment of the present invention, the one or more support users using the one or more external systems 124 may include, but not limited to, call centre executives, helpdesk personnel, customer care representatives, external DB operators etc. In various embodiments of the present invention, once the information related to the benefits is presented into the one or more pre-determined formats suitable for the one or more external systems 124, the control is transferred to the DB update engine 122 via the workflow manager 108 for updating the presented information.

The DB update engine 122 is configured to update the presented information related to the one or more benefits from the DB format translator 120 on the one or more external systems 124. The one or more external systems 124 are additional and existing systems that are updated with the information related to the one or more benefits. The one or more external systems 124 includes external databases and systems such as, but not limited to, helpdesk, call centre, Enterprise Information Portal (EIP) or corporate portal, Customer Relationship Management (CRM) system and their associated repositories.

In an exemplary embodiment of the present invention, in a call centre scenario, the DB format translator 120 filters and presents the information related to the benefits from the one or more BPDs into a pre-determined format. The information is then updated on the call centre database by the DB update engine 122 and rendered on computers of call centre executives in a more meaningful and useful manner which facilitates the call centre executives to provide information related to the benefits to the one or more subscribers dialing in to the call centre.

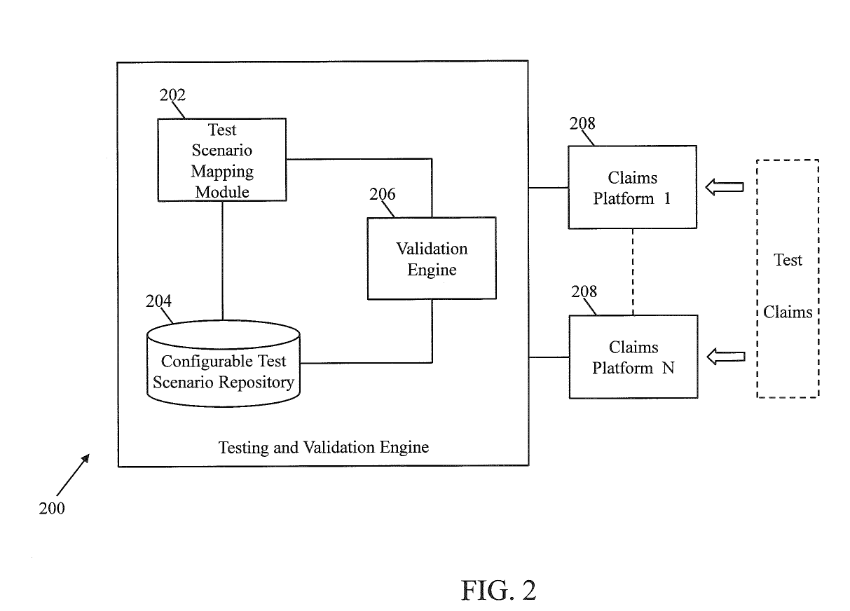

FIG. 2 is a detailed block diagram of the testing and validation engine in accordance with an embodiment of the present invention. The testing and validation engine 200 comprises a test scenario mapping module 202, a configurable test scenario repository 204 and a validation engine 206. The testing and validation engine 200 is connected to the one or more claims platforms 208.

The test scenario mapping module 202 is configured to generate one or more test claims corresponding to one or more test scenarios and one or more expected results based on the one or more mapped benefits. Further, the test scenario mapping module 202 facilitates testing of the updated codes or mnemonics (the coded benefits) using the generated one or more test claims and the one or more expected results. The one or more test scenarios ensure that all the process flows derived from the one or more BPDs are tested from end to end using the one or more test claims. The one or more test claims are test cases corresponding to the one or more test scenarios which are executed on the one or more claims platforms 208 to validate the updated codes or mnemonics (the coded benefits). At the time of configuring the system 100, the administrator creates and stores test scenarios corresponding to the pre-stored benefits in the configurable test scenario repository 204. In an embodiment of the present invention, the one or more test scenarios and the one or more test claims are generated from these pre-stored test scenarios and also by using the data and codes stored in the various lookup tables. In an exemplary embodiment of the present invention, the lookup tables for the purpose of testing include, but not limited to, services tables, conditions tables, etc.

In an embodiment of the present invention, the test scenario mapping module 202 fetches the pre-stored test scenarios corresponding to a service from the configurable test scenario repository 204. For example, the one or more mapped benefits may refer to a service related to an ailment such as allergy and the corresponding pre-stored test scenarios are fetched. The test scenario mapping module 202 then checks the coverage and the conditions associated with allergy and fetches appropriate codes from the conditions tables and the other lookup tables. The pre-stored test scenarios corresponding to allergy and the fetched codes are used to generate the one or more test scenarios and the one or more test claims specific to the coverage and conditions associated with allergy. The values related to coverage, deductibles, coinsurance, copayment etc. for allergy are associated with the generated one or more test scenarios and the one or more test claims to generate the one or more expected results.

Further, the test and validation engine 206 facilitates execution of the generated one or more test claims on one or more claims platforms 208 to generate the one or more actual test results. In various embodiments of the present invention, once the one or more actual test results are generated by the one or more claims platforms 208, the control is transferred to the validation engine 206 via the workflow manager 108 (FIG. 1).

The configurable test scenario repository 204 stores the one or more generated test scenarios, the one or more pre-stored test scenarios, the one or more expected results, the one or more test claims, the one or more actual test results and validation results. In various embodiments of the present invention, the configurable test scenario repository 204 may include any relational database management system such as, but not limited to, Oracle, DB2, SQL server, MS Access, MySQL and SQLite.

The validation engine 206 is configured to validate the updated codes or mnemonics to generate the validation results and is further configured to facilitate detecting and correcting one or more errors in the updated codes or mnemonics. The validation engine 206 facilitates matching the one or more actual test results with the one or more expected results to ascertain validity and accuracy of the codes or mnemonics updated on the one or more claims platforms 208. The validation engine 206 further facilitates detecting and correcting the one or more errors pertaining to the codes or mnemonics if the one or more actual test results do not match the one or more expected results.

In an embodiment of the present invention, the validation engine 206 includes program instructions and logic to match the one or more actual test results with the one or more expected results to generate the validation results. In an embodiment of the present invention, if the one or more actual test results match the one or more expected results for the one or more test scenarios then the codes or mnemonics updated on the one or more claims platforms 208 are considered valid. In another embodiment of the present invention, if the one or more actual test results do not match the one or more expected results then the codes or mnemonics representing the one or more benefits (the coded benefits) are considered invalid. In an embodiment of the present invention, the validation results for the test claims are displayed to the one or more users via the user interface 102 (FIG. 1). In another embodiment of the present invention, screenshots for invalid results are stored in the configurable test scenario repository 204 for future reference by the validation engine 206. In various embodiments of the present invention, output from the validation engine 206, the one or more detected errors, status of the one or more test scenarios, the one or more actual test results and the one or more expected results are reported via the user interface 102 (FIG. 1) in various forms such as, but not limited to, a Portable Document Format (PDF), a spreadsheet, a word processor document, an HTML document and a web page.

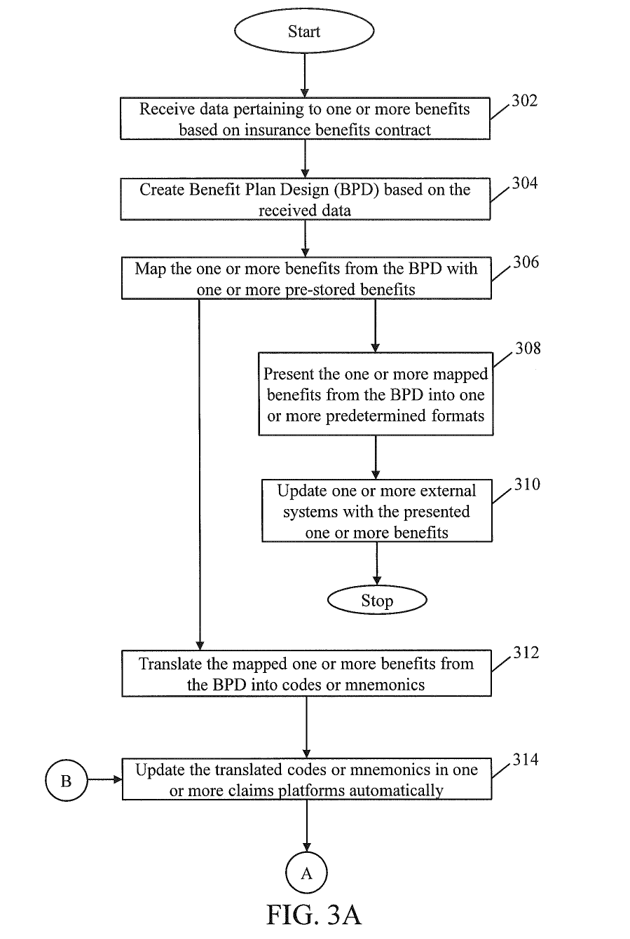

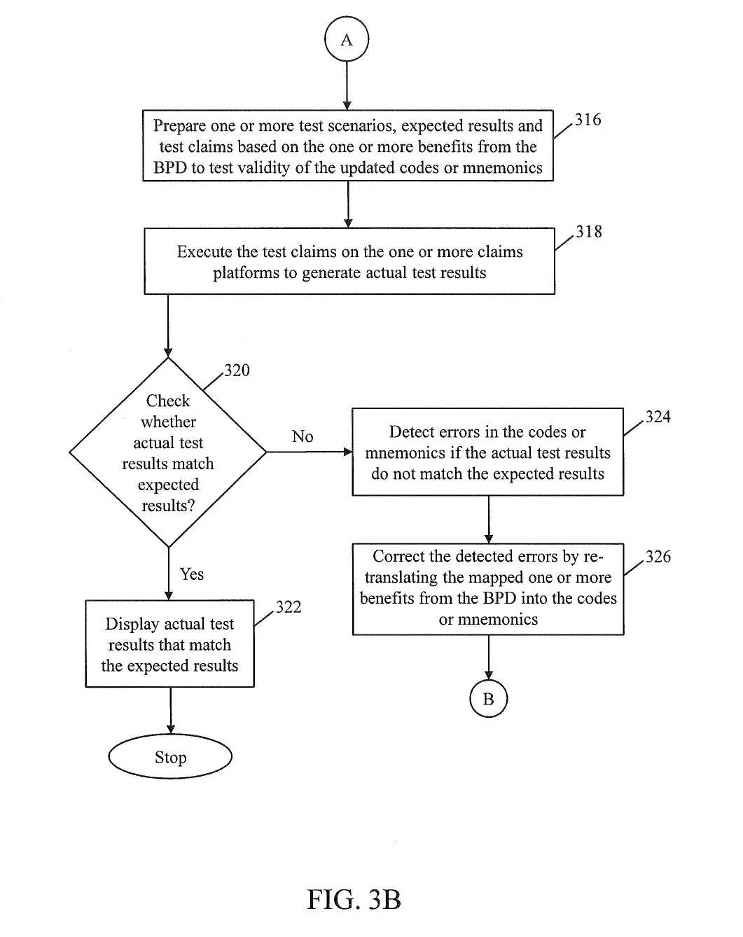

FIGS. 3A and 3B represent a flowchart illustrating a method for automated coding and testing of insurance benefits in accordance with an embodiment of the present invention.

At step 302, data pertaining to one or more benefits based on insurance benefits contract is received. The insurance benefits contract is a contract between one or more subscribers and a payer organization containing information such as, but not limited to, insurance coverage and benefit details provided by the payer organization to the one or more subscribers. Further, the received data pertaining to the one or more benefits includes, but not limited, coverage details, benefit details, eligibility details, copayment, co-insurance, and deductible values.

In an embodiment of the present invention, the data pertaining to the one or more benefits is entered using web forms by one or more users. In another embodiment of the present invention, the data pertaining to the one or more benefits is entered using one or more templates and is uploaded into the system. In yet another embodiment of the present invention, the one or more users selects the one or more benefits from a list of pre-stored benefits based on the insurance benefits contract. In various embodiments of the present invention, the one or more users include, but not limited to, benefits analysts, employees and sales executives of the payer organizations.

At step 304, one or more Benefit Plan Designs (BPDs) are created based on the received data. A BPD is a document comprising the benefits provided by the payer organization to the one or more subscribers, coverage details, benefits details, copayment, co-insurance, deductibles, eligibility details and additional technical details for configuring the insurance benefits contract and coding the benefits in the one or more claims platforms. Further, the BPD is based on the insurance benefits contract opted by an individual or a corporate on behalf of their employees with the payer organization. In an embodiment of the present invention, the data pertaining to the one or more benefits received from the one or more users via various interfaces such as, web forms, templates etc. is arranged in a predetermined order to create the BPD.

At step 306, the one or more benefits from the one or more created BPDs are mapped with one or more pre-stored benefits in the repository. In an embodiment of the present invention, an administrator creates a master list of pre-stored benefits containing all the benefits provided by the payer organization to the subscribers. Further, the administrator can also configure new benefits in the master list of the pre-stored benefits as and when required by the payer organization.

In an embodiment of the present invention, a list of the one or more pre-stored benefits is rendered on the user interface. The one or more users select the one or more benefits from the rendered list of the one or more pre-stored benefits based on the insurance benefits contract to create the one or more BPDs. The one or more benefits from the one or more created BPDs are mapped with the one or more pre-stored benefits to retrieve additional data related to the mapped one or more benefits including, but not limited to, copayment, coinsurance, deductibles, limits, etc. In an embodiment of the present invention, the mapped one or more benefits and the additional data is used for coding and testing of the one or more benefits. In various embodiments of the present invention, the one or more benefits from the one or more BPDs include at least one of: services covered, sub-services covered, coverage details, coinsurance, deductibles and copayment values.

At step 308, the one or more mapped benefits are presented into one or more predetermined formats that can be rendered on one or more external systems. In various embodiments of the present invention, information from the one or more mapped benefits is presented into useful and meaningful information that can be comprehended by one or more support users using the one or more external systems. At step 310, the presented one or more benefits are rendered on the one or more external systems. In an embodiment of the present invention, the presented one or more benefits are updated on the appropriate screens and fields of the one or more external systems. The one or more external systems include, but not limited to, a helpdesk, a call centre, an Enterprise Information Portal (EIP) or a corporate portal and a Customer Relationship Management (CRM) system and their associated repositories.

At step 312, the one or more mapped benefits are translated into codes or mnemonics. In an embodiment of the present invention, the codes or mnemonics are instructions specific to a claims platform provided by a vendor of the claims platform. The translated codes or mnemonics help in configuring one or more claims platforms with respect to insurance benefits contract to facilitate quick processing of claims made by the one or more subscribers and further facilitate early and correct payments.

In various embodiments of the present invention for translation, the one or more mapped benefits are again mapped with data in one or more lookup tables. The data in the one or more lookup tables comprises of: the mapped one or more benefits and corresponding codes or mnemonics which are provided by the vendor of the claims platform. In an embodiment of the present invention, during the step of translation, content of the one or more mapped benefits is matched with the one or more benefits in the one or more lookup tables and corresponding pre-stored codes and mnemonics are retrieved. In an embodiment of the present invention, some lookup tables are used for the purpose of coding of the one or more mapped benefits and some lookup tables are used only for the purpose of testing of the one or more mapped benefits. In an exemplary embodiment of the present invention, the one or more lookup tables for the purpose of coding include, but not limited to, services tables, conditions tables, parameter classification tables etc.

At step 314, the translated codes or mnemonics representing the one or more mapped benefits (coded benefits) are updated in the one or more claims platforms automatically. The vendor of the claims platform provides information which facilitates in updating the translated codes or mnemonics (the coded benefits) into various screens and fields of the claims platform.

At step 316, one or more test claims corresponding to one or more test scenarios and one or more expected results are generated based on the one or more mapped benefits. In an embodiment of the present invention, the one or more test scenarios ensure that all the process flows derived from the one or more BPDs are tested from end to end using the one or more test claims. The one or more test claims are test cases associated with the one or more test scenarios that are executed on the one or more claims platforms to validate and check accuracy of the updated codes or mnemonics (the coded benefits). In an embodiment of the present invention, the one or more test scenarios and the corresponding one or more test claims are generated from pre-stored test scenarios and also by using the data and codes stored in the various lookup tables. In an exemplary embodiment of the present invention, the lookup tables for the purpose of testing include, but not limited to, services tables, conditions tables, etc.

In an embodiment of the present invention, the pre-stored test scenarios corresponding to a service are fetched from a configurable test scenario repository. For example, the one or more mapped benefits may refer to a service related to an ailment such as allergy and its corresponding pre-stored test scenarios are fetched. The coverage and the conditions associated with allergy are checked and appropriate codes from the conditions tables and the other lookup tables are also fetched. The pre-stored test scenarios corresponding to allergy and the fetched codes are then used to generate the one or more test scenarios and corresponding one or more test claims. The values related to coverage, deductibles, coinsurance, copayment etc. for allergy are associated with the generated one or more test scenarios and the generated one or more test claims to generate the one or more expected results.

At step 318, the generated one or more test claims are executed on the one or more claims platforms having the updated codes or mnemonics (the coded benefits) to generate the one or more actual test results. In an embodiment of the present invention, the one or more test claims are executed automatically by updating the appropriate screens and fields of the one or more claims platforms with the one or more test claims.

At step 320, a check is performed to ascertain whether the generated one or more actual test results match the one or more expected results to validate the codes or mnemonics updated in the one or more claims platforms and thereby generate validation results. If the one or more actual test results match the one or more expected results, then at step 322, the one or more actual test results that match the one or more expected results are displayed to the one or more users. In an embodiment of the present invention, the one or more users are notified that the updated codes or mnemonics are valid and facilitate proper and accurate processing of the claims. If the one or more actual test results do not match the one or more expected results, then at step 324, one or more errors are detected and reported via the user interface. In another embodiment of the present invention, the screenshots of the detected one or more errors are stored along with the one or more actual test results. In yet another embodiment of the present invention, status of the one or more test scenarios is displayed via the user interface. In various embodiments of the present invention, the validation results, the one or more detected errors, status of the one or more test scenarios, the one or more actual test results and the one or more expected results may be displayed in various forms such as, but not limited to, a Portable Document Format (PDF), a spreadsheet, a word processor document, an HTML document and a web page.

At step 326, the one or more mapped benefits from the one or more BPDs are re-translated into appropriate codes or mnemonics to correct the detected one or more errors using the validation results. Steps 314 to 322 are repeated to update the re-translated codes or mnemonics on the one or more claims platforms and further perform testing.

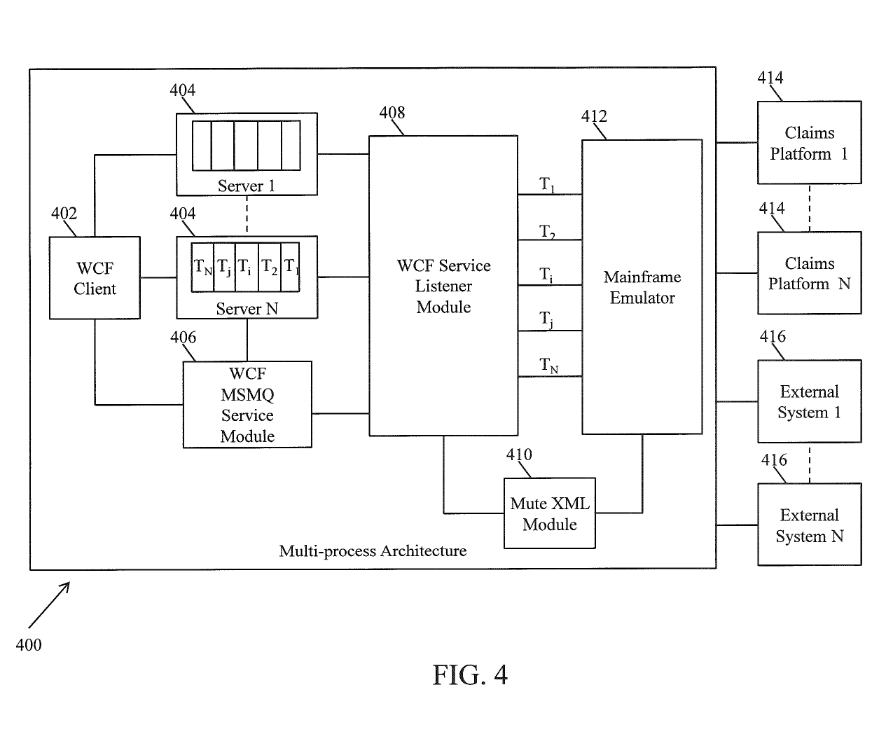

FIG. 4 illustrates a multi-process architecture for automated coding and testing of insurance benefits in accordance with an exemplary embodiment of the present invention.

The system 100 (FIG. 1) comprises a multi-process architecture 400 for coding and testing of the one or more benefits using parallel processing which facilitates to reduce turnaround time. In an embodiment of the present invention, the multi-process architecture 400 comprises various components such as a Windows Communication Foundation (WCF) client 402, one or more servers 404, a WCF Microsoft Message Queuing (MSMQ) service module 406, a WCF service listener module 408, a mute Extensible Markup Language (XML) module 410 and a mainframe emulator 412. The multi-process architecture 400 is connected to one or more claims platforms 414 and one or more external systems 416. In an embodiment of the present invention, the one or more claims platforms 414 and the one or more external systems 416 are mainframe based systems.

In various embodiments of the present invention, the multi-process architecture 400 facilitates updating translated codes and mnemonics into the one or more claims platforms 414, executing one or more test scenarios (T1-TN) on the one or more claims platforms 414 and updating the one or more mapped benefits previously presented in one or more pre-determined formats on the one or more external systems 416 using parallel processing.

In an embodiment of the present invention, the WCF client 402 checks availability of a messaging queue residing in the one or more servers 404 by communicating with the WCF MSMQ service module 406. The messaging queue is a temporary storage location where the translated codes or mnemonics, one or more test scenarios (T1-TN) and the associated one or more test claims and the one or more mapped benefits previously presented in one or more pre-determined formats are stored. The WCF MSMQ service module 406 is configured to create and manage the messaging queue in each of the servers 404. In an embodiment of the present invention, the WCF client 402 is configured to push the translated codes and mnemonics into the messaging queue residing in the one or more servers 404 during coding. In another embodiment of the present invention, the WCF client 402 is configured to push the generated one or more test scenarios (T1-TN) and the associated one or more test claims into the messaging queue residing in the one or more servers 404 during testing. In yet another embodiment of the present invention, the WCF client 402 pushes the one or more test scenarios (T1-TN) to the messaging queue of a particular server based on load on the other servers 404.

In an exemplary embodiment related to testing, the WCF service listener module 408 reads the one or more test scenarios (T1-TN) and the associated one or more test claims in the messaging queue. The WCF service listener module 408 then communicates with the mute XML module 410 to check availability of one or more mainframe sessions. The mute XML module 410 contains XML files that track and record the status of each of the one or more mainframe sessions. The one or more mainframe sessions facilitate multiple connections with the mainframe emulator 412 for parallel processing. Based on the status of the one or more mainframe sessions provided by the XML files, the WCF service listener module 408 assigns the one or more test scenarios (T1-TN) and the associated one or more test claims to the available one or more mainframe sessions. The WCF service listener module 408 then initiates parallel processing of the one or more test scenarios (T1-TN) and the associated one or more test claims assigned to the one or more mainframe sessions.

The mainframe emulator 412 facilitates execution of each of the one or more test scenarios (T1-TN) and the associated one or more test claims on the one or more claims platforms 414 simultaneously to validate the translated codes or mnemonics representing the mapped benefits. The translated codes or mnemonics are updated into the one or more claims platforms 414 using the various components of the multi-process architecture 400 as discussed with respect to the test scenarios. Once the one or more test scenarios (T1-TN) and its associated test claims are executed, the assigned one or more mainframe sessions are released and the WCF service listener module 408 again assigns the released one or more mainframe sessions for reuse by remaining test scenarios (T1-TN) waiting in the messaging queue.

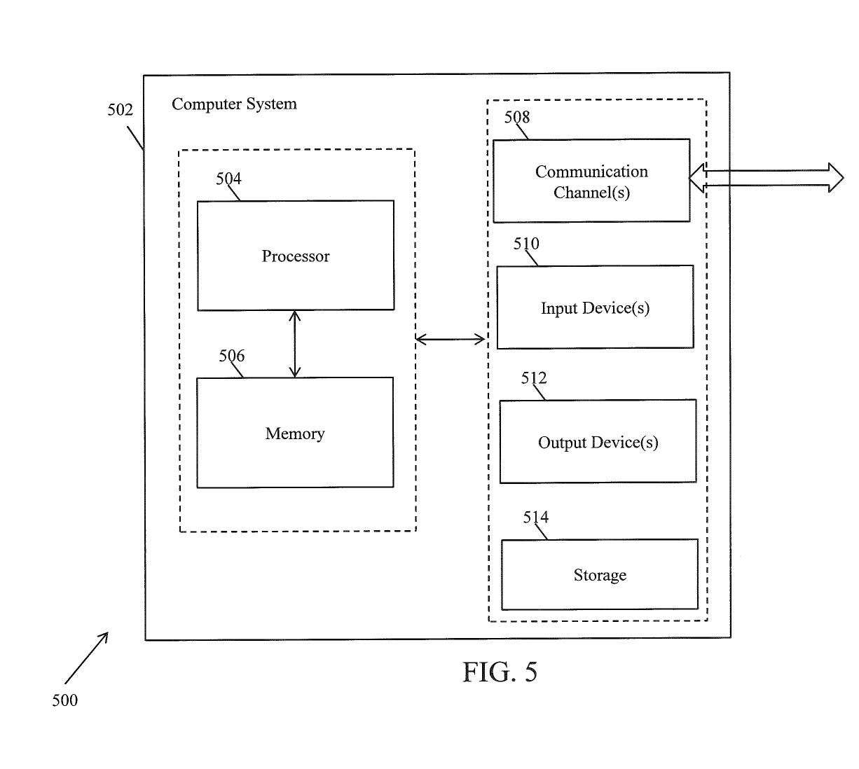

FIG. 5 illustrates an exemplary computer system for automated coding and testing of insurance benefits in accordance with an embodiment of the present invention.

The computer system 502 comprises a processor 504 and a memory 506. The processor 504 executes program instructions and may be a real processor. The processor 504 may also be a virtual processor. The computer system 502 is not intended to suggest any limitation as to scope of use or functionality of described embodiments. For example, the computer system 502 may include, but not limited to, a general-purpose computer, a programmed microprocessor, a micro-controller, a peripheral integrated circuit element, and other devices or arrangements of devices that are capable of implementing the steps that constitute the method of the present invention. In an embodiment of the present invention, the memory 506 may store software for implementing various embodiments of the present invention. The computer system 502 may have additional components. For example, the computer system 502 includes one or more communication channels 508, one or more input devices 510, one or more output devices 512, and storage 514. An interconnection mechanism (not shown) such as a bus, controller, or network, interconnects the components of the computer system 502. In various embodiments of the present invention, operating system software (not shown) provides an operating environment for various softwares executing in the computer system 502, and manages different functionalities of the components of the computer system 502.

The communication channel(s) 508 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 510 may include, but not limited to, a keyboard, mouse, pen, joystick, trackball, a voice device, a scanning device, or any another device that is capable of providing input to the computer system 502. In an embodiment of the present invention, the input device(s) 510 may be a sound card or similar device that accepts audio input in analog or digital form. The output device(s) 512 may include, but not limited to, a user interface on CRT or LCD, printer, speaker, CD/DVD writer, or any other device that provides output from the computer system 502.

The storage 514 may include, but not limited to, magnetic disks, magnetic tapes, CD-ROMs, CD-RWs, DVDs, flash drives or any other medium which can be used to store information and can be accessed by the computer system 502. In various embodiments of the present invention, the storage 514 contains program instructions for implementing the described embodiments.

The present invention may suitably be embodied as a computer program product for use with the computer system 502. The method described herein is typically implemented as a computer program product, comprising a set of program instructions which is executed by the computer system 502 or any other similar device. The set of program instructions may be a series of computer readable codes stored on a tangible medium, such as a computer readable storage medium (storage 514), for example, diskette, CD-ROM, ROM, flash drives or hard disk, or transmittable to the computer system 502, via a modem or other interface device, over either a tangible medium, including but not limited to optical or analogue communications channel(s) 508. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for automated coding and testing of benefits, the system comprising:
a user interface configured to receive data pertaining to one or more benefits based on one or more insurance benefits contracts and further configured to create one or more Benefit Plan Designs (BPDs) using the received data;
a benefits mapping module configured to map the one or more benefits from the created one or more BPDs with one or more pre-stored benefits in a repository;
a benefit code translator configured to translate the one or more mapped benefits into codes or mnemonics;
a benefit code updating engine configured to update the translated codes or mnemonics into one or more claims platforms;
a test scenario mapping module configured to generate one or more test claims and one or more expected results based on the one or more mapped benefits and further configured to execute the generated one or more test claims on the one or more claims platforms having the updated codes or mnemonics to generate one or more actual test results; and
a validation engine configured to validate the updated codes or mnemonics by matching the generated one or more actual test results with the one or more expected results.

2. The system of claim 1, wherein the user interface provides at least one of: web forms and templates to receive the data pertaining to the one or more benefits.

3. The system of claim 1, wherein the received data related to the one or more benefits includes at least one of: benefit details, coverage details, copayment, coinsurance and deductible values.

4. The system of claim 1, wherein the one or more insurance benefits contracts contain information related to at least one or more insurance benefits provided by a payer organization to one or more subscribers.

5. The system of claim 1, wherein the received data is arranged in a predetermined order to create the one or more BPDs.

6. The system of claim 1, wherein the repository stores at least one of: the one or more pre-stored benefits, the received data, the created one or more BPDs, web forms and templates.

7. The system of claim 1, wherein the one or more pre-stored benefits include at least one of: services covered, sub-services covered, coverage details, coinsurance, deductible and copayment values.

8. The system of claim 1, wherein the benefit code translator is configured to translate the one or more mapped benefits into the codes or mnemonics by matching the one or mapped benefits with data in one or more lookup tables and fetching the codes or mnemonics corresponding to the matched data.

9. The system of claim 1, wherein the generated one or more test claims correspond to one or more test scenarios.

10. The system of claim 1, wherein values related to at least one of: deductible, coinsurance, copayment and coverage from the one or more mapped benefits are associated with the generated one or more test claims to generate the one or more expected results.

11. The system of claim 1 further comprising: a configurable test scenario repository for storing at least one of: one or more pre-stored test scenarios, the one or more test scenarios, the one or more expected results, the one or more test claims and the one or more actual test results.

12. The system of claim 1, wherein if the one or more actual test results do not match the one or more expected test results then one or more errors in the updated codes or mnemonics are detected and reported.

13. The system of claim 1, wherein output from the validation engine is reported via the user interface in various forms including at least one of: a Portable Document Format (PDF), a spreadsheet, a word processor document, a HyperText Markup Language (HTML) document and a web page.

14. The system of claim 1, wherein the translated codes or mnemonics are updated into the one or more claims platforms using a multi-process architecture.

15. The system of claim 14, wherein the generated one or more test claims are executed on the one or more claims platforms having the updated codes or mnemonics using the multi-process architecture.

16. The system of claim 1 further comprising:
a database format translator configured to present the one or more mapped benefits into one or more pre-determined formats; and
a database update engine configured to update the presented one or more benefits on one or more external systems.

17. The system of claim 16, wherein the one or more external systems include at least one of: a helpdesk system, a call centre system, an Enterprise Information Portal (EIP), a corporate portal, a Customer Relationship Management (CRM) system and their associated repositories.

18. A computer-implemented method for automated coding and testing of benefits, via program instructions stored in a memory and executed by a processor, the computer-implemented method comprising:
receiving data pertaining to one or more benefits based on one or more insurance benefits contracts;
creating one or more Benefit Plan Designs (BPDs) using the received data pertaining to the one or more benefits;
mapping the one or more benefits from the created one or more BPDs with one or more pre-stored benefits;
translating the one or more mapped benefits into codes or mnemonics;
updating the translated codes or mnemonics into one or more claims platforms;
generating one or more test claims and one or more expected results based on the one or more mapped benefits;
executing the generated one or more test claims on the one or more claims platforms having the updated codes or mnemonics to generate one or more actual test results; and
validating the updated codes or mnemonics by matching the generated actual test results with the expected results.

19. The computer-implemented method of claim 18, wherein the step of translating comprises:
matching the one or mapped benefits with data in one or more lookup tables; and
fetching the codes or mnemonics corresponding to the matched data.

20. The computer implemented method of claim 18, further comprising:
presenting the one or more mapped benefits into one or more pre-determined formats; and
updating the presented one or more benefits on one or more external systems.

21. A computer program product for automated coding and testing of benefits, the computer program product comprising:
a non-transitory computer-readable medium having computer-readable program code stored thereon, the computer-readable program code comprising instructions that when executed by a processor, cause the processor to:
receive data pertaining to one or more benefits based on one or more insurance benefits contracts;
create one or more Benefit Plan Designs (BPDs) using the received data pertaining to the one or more benefits;
map the one or more benefits from the created one or more BPDs with one or more pre-stored benefits;
translate the one or more mapped benefits into codes or mnemonics;
update the translated codes or mnemonics into one or more claims platforms;
generate one or more test claims and one or more expected results based on the one or more mapped benefits;
execute the generated one or more test claims on the one or more claims platforms having the updated codes or mnemonics to generate one or more actual test results; and
validate the updated codes or mnemonics by matching the generated actual test results with the expected results.

22. The computer program product of claim 21, wherein translating the one or more mapped benefits into codes or mnemonics comprises:
matching the one or mapped benefits with data in one or more lookup tables; and
fetching the codes or mnemonics corresponding to the matched data.

23. The computer program product of claim 21, further comprising:
presenting the one or more mapped benefits into one or more pre-determined formats; and
updating the presented one or more benefits on one or more external systems.
